(19) United States
(12) Patent Application Publication
(10) Pub. No.: US 2007/0253598 A1
(43) Pub. Date: Nov. 1, 2007

(54) IMAGE MONITORING APPARATUS

(75) Inventors: Mayumi Yuasa, Kawasaki-shi (JP); Masashi Nishiyama, Yokohama-Shi (JP); Tomokazu Wakasugi, Tokyo (JP); Tomoyuki Shibata, Kawasaki-shi (JP); Osamu Yamaguchi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/740,465

(22) Filed: Apr. 26, 2007

(30) Foreign Application Priority Data
Apr. 27, 2006 (JP) 2006-124149

(51) Int. Cl. G06K 9/00

(52) U.S. Cl. 382/104

(57) ABSTRACT

An image monitoring apparatus includes: plural cameras, each of which obtains a plurality of images; a detection unit that detects an area occupied by at least one target candidates from each of the plural images; a storage that stores a first data for recognizing at least one target; a recognizing unit that recognizes the at least one target in each of the areas based on the first data; a camera evaluation unit that obtains evaluation values for respective cameras based on the plural images obtained by the respective cameras; a selection unit that selects one of the cameras based on the evaluation values; and an output unit that outputs a recognition obtained by using one of the plural images obtained by the selected one of the cameras.

### CROSS-REFERENCE TO RELATED APPLICATIONS

This application is based upon and claims the benefit of priority from Japanese Patent Application No. 2006-124149, filed on Apr. 27, 2006, the entire contents of which are incorporated herein by reference.

### BACKGROUND

1. Field

The present invention relates to an image monitoring apparatus that enables to select a proper camera when a target moving in a given area is recognized by plural cameras.

2. Related Art

A conventional apparatus for monitoring a walker requires that a camera is installed so that the camera easily recognizes the face of the walker (for example, JP-A-2001-16573).

However, the camera cannot be always installed where the camera theoretically easily recognizes the face of the walker in all installation places. Also, depending on the kinds of cameras and the conditions of illumination, the cameras cannot be always installed in the optimum manner.

Further, in the image of the same camera, there exist areas where no walker appears or, even if a walker appears, no processing can be carried out in an area; and also, the distribution of such areas changes according to situations. Because of this, it is difficult to determine the installation arrangement of the monitoring camera in such a manner that it can cope with these circumstances in any case.

As described above, the camera cannot be always installed so that the camera easily recognizes the face of the walker in any installation places.

### SUMMARY

According to an aspect of the invention, there is provided an image monitoring apparatus that includes a plurality of cameras, and evaluates the relative performance of the cameras to thereby be able to properly select a camera to be used for outputting of the results or a camera to be operated actually.

According to an aspect of the invention, there is provided an image monitoring apparatus includes: plural cameras, each of which obtains a plurality of images; a detection unit that detects an area occupied by at least one target candidates from each of the plural images; a storage that stores a first data for recognizing at least one target; a recognizing unit that recognizes the at least one target in each of the areas based on the first data; a camera evaluation unit that obtains evaluation values for respective cameras based on the plural images obtained by the respective cameras; a selection unit that selects one of the cameras based on the evaluation values; and an output unit that outputs a recognition result obtained by using one of the plural images obtained by the selected one of the cameras.

### BRIEF DESCRIPTION OF THE DRAWINGS

In the accompanying drawings:

FIG. 1 is a block diagram of an image monitoring apparatus according to a first embodiment of the invention;

FIG. 2 is a flow chart of an operation to be performed for personal recognition according to the first embodiment;

FIG. 3 is a flow chart of an operation to be performed for a camera determining processing according to the first embodiment;

FIG. 4 is a view of an example for arrangement of cameras;

FIG. 5 is s a block diagram of an image monitoring apparatus according to a second embodiment;

FIG. 6 is a flow chart of an operation to be performed for attribute recognition according to the second embodiment;

FIG. 7 is a flow chart of an operation to be performed for a camera determining processing according to the second embodiment;

FIG. 8 is an exemplary view according to a fifth embodiment of the invention; and

FIG. 9 is an exemplary view according to the fifth embodiment.

### DETAILED DESCRIPTION

Now, description will be given below of embodiments of an image monitoring apparatus according to the invention with reference to the accompanying drawings.

### First Embodiment

An image monitoring apparatus according to the first embodiment includes a plurality of cameras 101 each of which obtains an image, a detection unit 102 that detects an area of the face of a person presenting in the image, a selection unit 103 that selects a camera for obtaining an image which can be used for recognition, an evaluation storage 104 that stores the evaluation values for the respective cameras, a recognizing unit 105 that recognizes a person, a dictionary storage (storage) 106 that stores a dictionary for recognition (data for recognizing the person), and an output unit 107 that outputs the results of recognition made by the recognizing unit 105.

The first embodiment is an apparatus which monitors a passage in a building and recognizes who a person passing by the passage is. The selection unit 103 according to the first embodiment selects, of the plural cameras 101, a camera which provides the largest number of character faces detected.

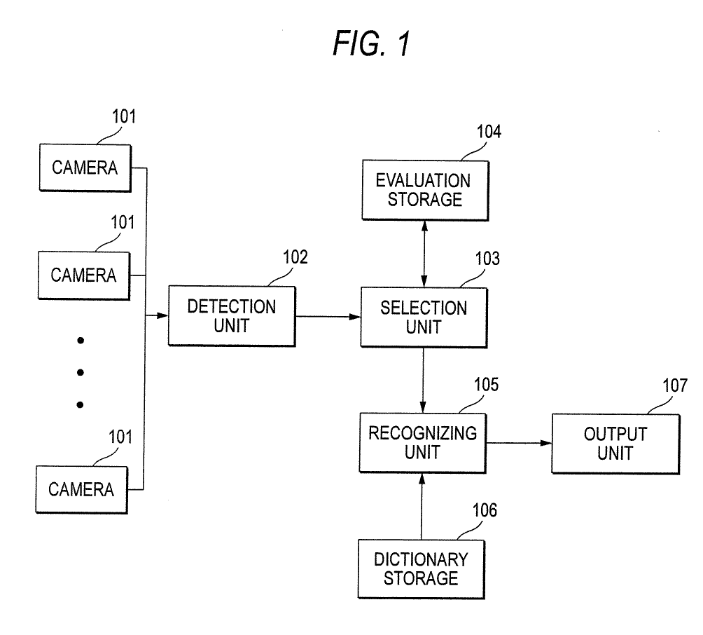

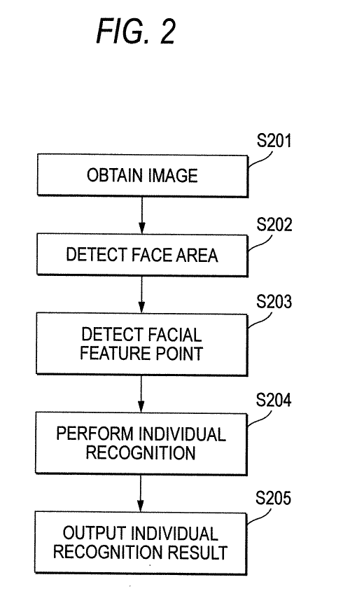

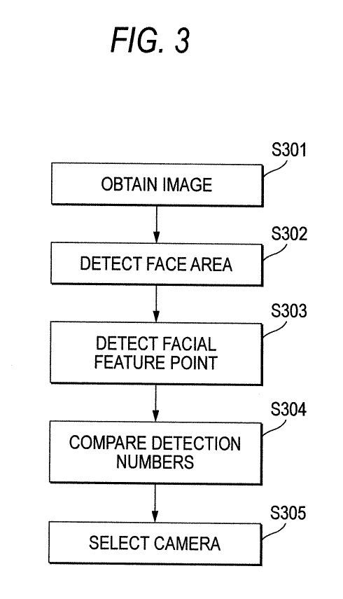

Next, description will be given below of the operation of the image monitoring apparatus according to the first embodiment with reference to FIGS. 1, 2 and 3. FIG. 2 is a flow chart to show an operation to be performed in a normal person recognition processing. FIG. 3 is a flow chart to show the operation of a camera determining processing to be performed by an image monitoring apparatus according to the present embodiment. These two kinds of operations are carried out in parallel; however, to simplify the explanation thereof, the description thereof will be given below separately.

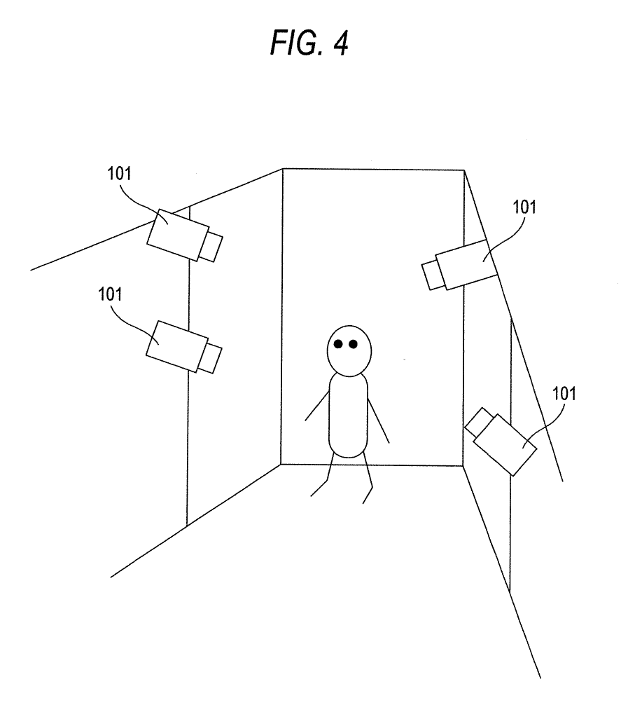

FIG. 4 shows an example of installation of the cameras 101 of the image monitoring apparatus according to the present embodiment. According to the first embodiment, monitoring is carried out from various angles using the plural cameras 101. And, the selection unit 103 selects the camera 101 that can detect the largest number of faces.

Now, description will be given below of the operation of a camera determination processing with reference to FIG. 3.

The cameras 101 obtain images (Step S301).

The detection unit 102 detects, in the thus obtained images, a face area image which is an image of a face area (Step S302). The detection of the face area is carried out according to a method disclosed in “Proposal of Joint Harr-like suitable for face detection” provided by Yuji Mita, Toshimitsu Kaneko, and Osamu Hori, Meeting on Image Recognition and Understanding (MIRU2005), pp. 104-111, 2005.

The detection unit 102 detects the feature points of the face from the face area image detected (Step S303). The detection unit 102 according to the first embodiment detects four kinds of points, that is, right and left pupils, right and left nostrils, as the facial feature points using a method disclosed in “Extraction of facial feature points by combination of shape extraction and pattern check”, The Transactions the Institute of Electronics Information and Communication Engineers of Japan (D-II), Vol. J80-D-II, No. 8, pp. 2170-2177, provided by Kazuhiro Fukui and Osamu Yamaguchi, August 1997.

The detection unit 102 outputs to the selection unit 103 an image including a face area image, facial feature points detected from the face area image of the image and an identifier for a camera 101 that has obtained the image.

The selection unit 103 counts the number of face area images from which four kinds of facial feature points are detected in plural frames (images) obtained for a given period by the respective cameras 101, as the face detect numbers of the respective cameras. And, the selection unit 103 allows the evaluation storage 104 to store the face detect numbers of the respective cameras and identifiers in such a manner that they correspond to each other (Step S304).

The selection unit 103 compares the face detect numbers between the cameras 101 and selects a camera 101 that provides the largest face detect numbers. The selection unit 103 allows the evaluation storage 104 to store an identifier for the camera selected (Step S305).

Next, description will be given below of a normal person recognition processing with reference to FIG. 3.

Processings to be performed by the image pickup unit 101 and detection unit 102 are similar to the processings to be performed in the camera determining processing (Steps S201 and S202).

The selection unit 103, while referring to the evaluation storage 104, selects, of the detect results containing the face area images and facial feature points outputted from the detection unit 102, the detect result that corresponds to the selected camera 101. And, the selection unit 103 supplies the selected detect result to the recognizing unit 105.

The recognizing unit 105 normalizes the image of the face area using the facial feature points detected by the detection unit 102 and also verifies it with the dictionary (data) of a person stored in the dictionary storage 106.

The recognizing unit 105 according to the present embodiment carries out the recognition of the person using a face recognition method disclosed in “face image recognition using a multiple constrained mutual subspace method” proposed in the IEICE Transactions on Information and Systems, D-11 Vol. J88-D-11, No. 8, pp. 1339-1348, 2005 by Nishiyama et al.

The recognizing unit 105 outputs the recognition result to the output unit 107.

The image monitoring apparatus according to the first embodiment carries out the above-mentioned camera determining processing and the person recognition processing in parallel. In other words, the selection unit 103, while performing the camera determining processing in real time, supplies the detect results corresponding to the cameras selected at the respective times to the recognizing unit 105.

In the first embodiment, the camera determining processing and the person recognition processing are carried out in parallel. However, these two processings need not be always performed in parallel but the camera selection may also be made according to the results of face detect ratios in a predetermined period.

As described above, according to the image monitoring apparatus of the first embodiment, the plural cameras are installed and the relative performance of these cameras is evaluated, whereby a camera to be used for the output of the result can be selected properly.

### Second Embodiment

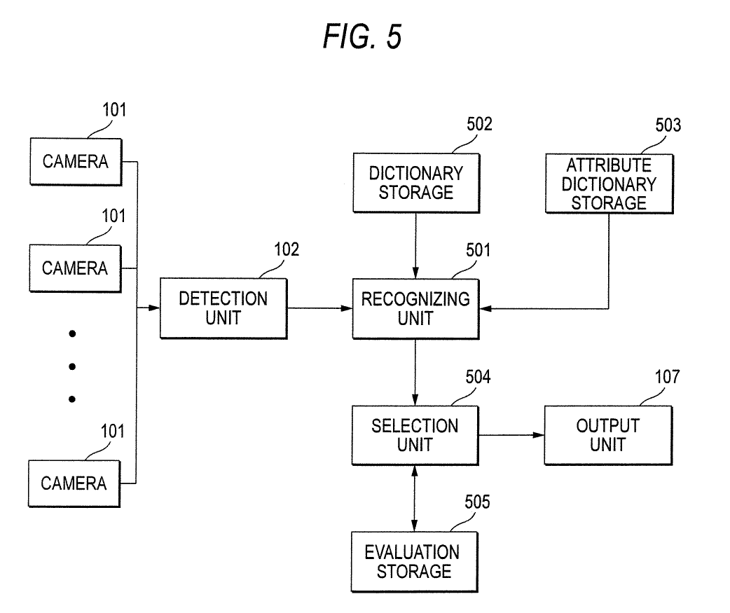

Now, description will be given below of an image monitoring apparatus according to a second embodiment of the invention with reference to the accompanying drawings. FIG. 5 is a block diagram of an image monitoring apparatus according to the second embodiment of the invention. In FIG. 5, parts used in common with the first embodiment are given common reference characters. Description will be given here mainly of the parts of the second embodiment that are different from the first embodiment.

The image monitoring apparatus according to the present embodiment includes plural cameras 101, each of which obtains an image, a detection unit 102 that detects an image of the face area of a person presenting in the obtained image, a dictionary storage 502 that stores individual dictionaries (data) for individual recognition that recognizes individual people, an attribute dictionary storage 503 that stores attribute dictionaries (data) for attribute recognition, a recognizing unit 501 that carrying out individual recognition and attribute recognition, an evaluation storage 505 that storing the correct answer ratios of the attribute recognition based on images supplied from the respective cameras 101, a selection unit 504 that selects recognition results based on the correct answer ratios of the attribute recognition of the respective cameras 101, and an output unit 107 that outputs the recognition results.

The image monitoring apparatus according to the second embodiment is an image monitoring apparatus which monitors the passage of a building and recognizes the attributes (the gender, ages and the like) of people or individuals passing by through the passage, and also which selects, of the plural cameras 101, the camera that provides the highest attribute recognition correct answer ratio. In the second embodiment, the attribute recognition answer correct ratio is obtained using the results of the individual recognition of people registered.

Now, description will be given below of the operation of the image monitoring apparatus according to the second embodiment.

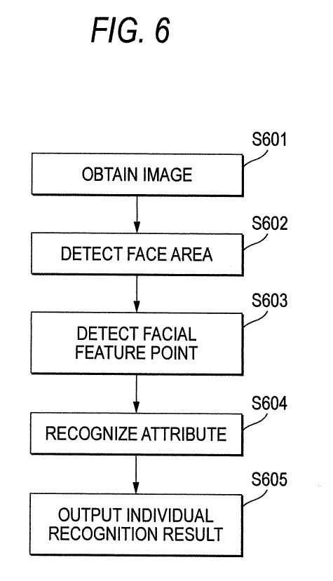

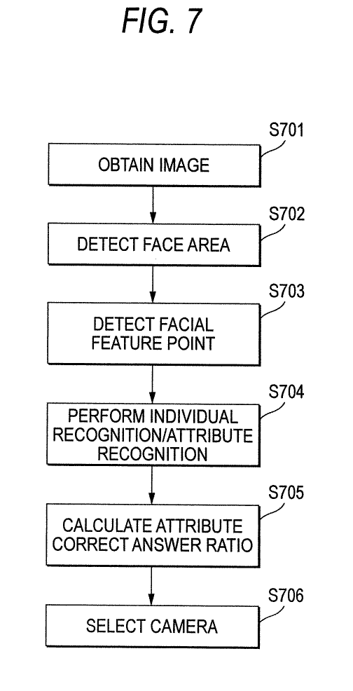

FIG. 6 is a flow chart of the operation of the image monitoring apparatus according to the second embodiment in the normal attribute recognition thereof. FIG. 7 is a flow chart of an operation to be performed in the camera determining processing of the image monitoring apparatus of the second embodiment. These two kinds of operations are carried out in parallel. However, for simplification, they will be described below separately.

Firstly, description will be given of the operation to be performed in the camera determining processing. Image input by the cameras 101 (Step S701) is similar to the step S201 in the first embodiment.

Detection of face area images by the detection unit 102 (Step S702) is similar to the step S202 in the first embodiment. Also, detection of facial feature points by the detection unit 102 (Step S703) is similar to the step S203 in the first embodiment. The detection unit 102 outputs facial feature points, face area images and an identifier for the camera 101 having obtained an image for a detecting processing to the recognizing unit 501.

An individual recognition operation to be performed by the recognizing unit 501 using the dictionaries of the dictionary storage 502 (Step S704) is similar to the step S204 in the first embodiment. However, it is assumed that the attributes of the people are previously recorded in the dictionary storage 502 together with the person dictionaries.

Next, attribute correct answer ratios are calculated (Step S704). The recognizing unit 501 according to the second embodiment recognizes the attributes of a target person using the attribute dictionary stored in the attribute dictionary storage 503. The recognizing unit 501 according to the second embodiment recognizes the gender of the target person. The attribute dictionaries to be stored in the attribute dictionary storage 503 are dictionaries used to determine the gender, obtained by generating a male dictionary and a female dictionary from the faces of a person whose gender is previously known.

The recognizing unit 501 normalizes the face area image using the facial feature points detected. And, the recognizing unit 501 recognizes the attributes of the target person with the male and female dictionaries and selects one which has a higher similarity. For the recognition, similarly to the individual recognition operation, there is used the mutual subspace method.

The recognizing unit 501 compares the gender found by the attribute recognition with the gender found by the individual recognition. When it is found that the result of the attribute recognition coincides with the result of the individual recognition, the recognizing unit 501 determines that it is a correct answer. When they are not coincident with each other, the recognizing unit 501 determines that it is not a correct answer.

The recognizing unit 501 outputs the determining result to the selection unit 504 together with an identifier for the camera 101.

The selection unit 504 calculates the correct answer ratios of the attribute recognition within a predetermined time of the respective cameras 101 and allows the evaluation storage 505 to store the thus calculated correct answer ratios. Also, the selection unit 504 selects a camera 101 which provides the highest attribute recognition correct answer ratio within the predetermined time and allows the evaluation storage 505 to store the thus selected camera 101.

Next, description will be given below of an operation to be performed in the normal attribute recognition. Image input, face area detection and facial feature point detection are similar to those in the operation of the camera determining processing (Steps S601 to S603). Also, attribute recognition is performed using the similar method to the attribute recognition in the camera determining processing.

The recognizing unit 501 outputs the results of the attribute recognition based on the images of the respective cameras 101 to the selection unit 504 in such a manner that they correspond to the identifiers of the respective cameras (Step S604).

The selection unit 504, while referring to the evaluation storage 505, selects the result of the attribute recognition based on the image of the camera 101 determined in the camera determining processing. And, the output unit 107 outputs the result of the attribute recognition selected (Step S605).

As described above, according to the image monitoring apparatus of the second embodiment, there are installed plural cameras and these cameras are respectively evaluated in their relative performance, thereby being able to properly select the camera that can be used in the output of the result.

### Third Embodiment

An image monitoring apparatus according to a third embodiment of the invention has a configuration similar to the image monitoring apparatus according to the second embodiment. The image monitoring apparatus according to the third embodiment can also be shown by the block diagram of FIG. 5. The image monitoring apparatus according to the third embodiment is different from the image monitoring apparatus according to the second embodiment in the method for calculating the correct answer ratio of the attribute recognition.

Now, description will be given below of the method for calculating the correct answer rate of the attribute recognition according to the third embodiment. In the third embodiment as well, there is used gender (male and female) as the attribute.

The recognizing unit 501 according the present embodiment finds the majority decision of the attribute recognition results of all cameras 101, and compares the result of the majority decision with the attribute recognition results of the respective cameras 101. And, when they coincide with each other, the recognizing unit 501 determines it to be a correct answer; and, when they don't coincide, the recognizing unit 501 determines it to be an incorrect answer. The recognizing unit 501 outputs the determining results and the identifiers of the cameras 101 to the selection unit 504.

The selection unit 504 finds the attribute correct answer ratios of the respective cameras within a predetermined period and selects the camera the correct answer ratio of which is highest.

### Fourth Embodiment

An image monitoring apparatus according to a fourth embodiment of the invention uses a camera. The field of view of the camera can be variably controlled, and selects control parameters used to control the view of the camera variably. That is, the camera is controllable to have plural fields of view. As elements which can vary the view of a camera, there can be pointed out, for example, the direction, zoom and focal distance of the camera. The image monitoring apparatus according to the fourth embodiment includes a camera all elements of which can be variably controlled.

The basic configuration of the fourth embodiment is similar to those of the first to third embodiments. However, in the first to third embodiments, since the optimum camera is selected from plural cameras, the cameras can be evaluated with the same target as the standard. On the other hand, in the fourth embodiment, since plural control parameters are selected for a camera, the performance of the camera cannot be evaluated simultaneously. Thus, for each of the parameters, the performance of the camera is evaluated while a period to be operated is shifted. For example, the camera is evaluated in such a manner that the control parameters are changed every predetermined time.

According to the fourth embodiment, the parameters of the camera can be determined properly according to situations. When the parameters of the movable camera are properly determined once, the movable camera may also be replaced with a fixed camera which has parameters equivalent to the parameters of the movable camera. In this case, there can be obtained a relatively inexpensive system.

### Fifth Embodiment

In a fifth embodiment according to the invention, by limiting an area where a face in an image can be detected easily, cost necessary for a processing can be saved. The fifth embodiment is used in combination with the first to fourth embodiments.

The detection unit 102, when face areas or facial feature points are detected, previously records, for example, the barycenter coordinates thereof. The detection unit 102 divides an image into given areas and finds the degrees of detection easiness of the respective areas according to the detection numbers or detection ratios in the respective areas. The image monitoring apparatus according to the fifth embodiment further includes a setting unit that presumes a presumption area that is apt to be detected by the detection unit 102 as the face area where the target exists and may set the presumption area as a detection area of the detection unit 102.

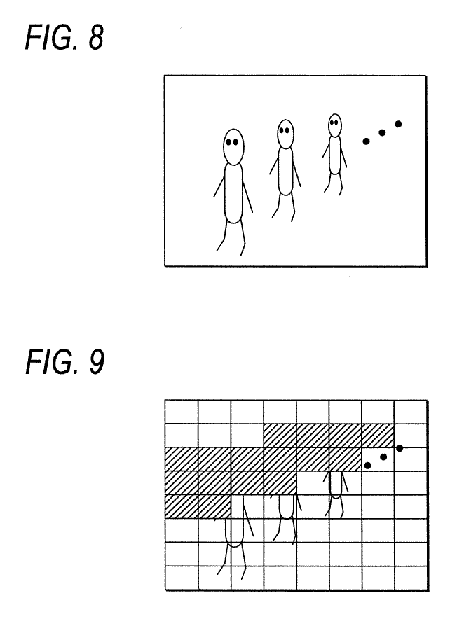

FIG. 8 shows an image at a certain time. Areas shown by oblique lines in FIG. 9 are areas in which, in the image of FIG. 8, the face areas are easy to detect. As regards the areas where the face areas or facial feature points have not been detected at all within a predetermined period, the detection unit 102 does not enforce any further processing on such areas, or sets detection-time parameters in such a manner that the accuracy of the face detection processing can be roughened. In this case, the areas where the processing in the image is not necessary can be determined, thereby being able to save cost.

Further, in the respective areas, the scale of the face detection can be set. For example, when it is determined that the areas of the image on this side are large and, in the areas of the image on the deep side, only a small face is found, the detection can be executed efficiently along such determination. For example, the sizes of the face areas detected may be previously stored and a detection processing may be started in the size decreasing order.

### Modification

The facial feature point detection in the detection unit 102 is processed in the face area. However, this is not limitative. Also, as the facial feature points, there are detected the four points, that is, the right and left pupils and the right and left nostrils; but, this is not limitative. For example, the ends of a mouth, the outer and inner corners of the eyes, the tails of eyebrows, the top of a nose and the like may also be detected.

In the recognizing units 105 and 501, the individual recognition based on the face is carried out according to the mutual subspace method. However, it is also possible to use other methods than the mutual subspace method according to the above-mentioned embodiments, provided that they are based on the face image.

In the above-mentioned embodiments, as the attribute, there is used the gender classification. However, as the attribute based on the face, there can also be used the presence or absence of glasses, the age, the presence or absence of a mustache, the presence or absence of a mask, the color of hair and a race; and, as the attribute not based on the face, there can also be used height, build and the like. Further, different cameras may be used to detect the respective attributes. Cameras, which are not used, may also be removed.

In the above-mentioned embodiments, as the method for measuring the number of walkers and recognizing individuals, there has been shown the method that uses the image of the face. However, it is not always necessary to use the face but the measurement and individual recognition may also be carried out using other parts of a body than the face. Also, the image may not be used but, by using other ID recognition unit such as RFID (radio tag), the number of walkers may be measured and the individual recognition may be preformed. In this case the image monitoring apparatus further includes a wireless reading unit that obtains attribute data of walkers from the tags attached to respective walkers.

In the above-mentioned embodiments, there has been shown an example in which the parameters of the camera 101 are changed; however, the image processing parameters may be changed. For example, parameters or threshold values, which relate to the scale of a target to be detected, may be changed.

The selection units 103 and 504 does not always need to select the best one of the cameras 101 but may select plural of the cameras 101. In this case, since the performance of the cameras can differ depending on the manner of combination of them, it is necessary to select the cameras based on the performance thereof with the combination thereof taken into account.

The cameras and parameters to be selected may not be fixed but they may also be changed dynamically according to the time, season and other conditions. This makes it possible to apply the invention to a place where illumination or the like varies greatly.

In the above-mentioned embodiments, there has been shown a case where a target is a walker but the target is not limited to the walker. For example, the target may be a vehicle. That is, when the number of vehicles is detected using cameras installed on the road, the optimum camera may be selected depending on the number of vehicles detected.

By the way, the invention is not limited to the above-mentioned embodiments but, in an actually practicing stage, the composing elements of the invention can be modified without departing from the range of the invention. Also, by combining together the plural composing elements disclosed in the above-mentioned embodiments in a proper manner, various inventions can be generated. For example, some composing elements may be removed from all composing elements shown in the above-mentioned embodiments. Further, the composing elements used in the different embodiments may be combined together according to cases.

What is claimed is:

1. An image monitoring apparatus comprising:
a plurality of cameras, each of which obtains a plurality of images;
a detection unit that detects an area occupied by at least one target candidates from each of the plurality of images;
a storage that stores a first data for recognizing at least one target;
a recognizing unit that recognizes the at least one target in each of the areas based on the first data;
a camera evaluation unit that obtains evaluation values for respective cameras based on the plurality of images obtained by the respective cameras;
a selection unit that selects one of the cameras based on the evaluation values; and
an output unit that outputs a recognition result obtained by using one of the plurality of images obtained by the selected one of the cameras.

2. The image monitoring apparatus according to claim 1, wherein the evaluation values for respective cameras indicate degrees of ability to obtain images recognizable in the recognizing unit.

3. The image monitoring apparatus according to claim 1,
wherein each of the at least one target includes a person, and
wherein the evaluation values for respective cameras are obtained based on numbers of people detected by detection unit in the plurality of images obtained by the respective cameras.

4. The image monitoring apparatus according to claim 1,
wherein the storage stores a second data for recognizing an attribute of the at least one target,
wherein the recognizing unit recognizes the attribute of the at least one target in each of the areas detected by the detection unit based on the second data, and
wherein the evaluation values for respective cameras are obtained based on results of the recognizing the attribute from the plurality of images obtained by the respective cameras.

5. The image monitoring apparatus according to claim 4,
wherein the storage stores a plurality of target data of a plurality of targets and a plurality of attribute data of the targets, each attribute data being in associated with corresponding target data, and
wherein the evaluation values for respective cameras are obtained based on match rates in comparisons between the attributes of some of the targets recognized by the recognizing unit and the attribute data stored in associated with the some of the targets recognized by the recognizing unit from the plurality of images obtained by the respective cameras.

6. The image monitoring apparatus according to claim 4, further comprising a wireless reading unit that obtains a plurality of attribute data of a plurality of targets from tags attached to respective targets,
wherein the evaluation values for respective cameras are obtained based on match rates in comparisons between the attribute data of some of the targets obtained by corresponding tags and the attribute data stored in associated with the some of the target recognized by the recognizing unit from the plurality of images obtained by the respective cameras.

7. An image monitoring apparatus comprising:
a camera that obtains an image;
a detection unit that detects an area where a target candidate occupies in the image;
a storage that stores a data for recognizing a target;
a recognizing unit that recognizes the target in the area of the image obtained by the camera based on the data stored in the storage;
a presuming unit that presumes a presumption area that is apt to be detected by the detection unit as the area where the target candidate occupies based on a result of recognizing the target;
a setting unit that sets the presumption area as a detection area of the detection unit; and
an output unit that outputs a result of recognizing the target from the image obtained by the camera.

8. An image monitoring apparatus comprising:
a camera that is controllable to have a plurality of fields of view and obtains an image in each of the fields of view;
a detection unit that detects an area occupied by a target candidate from each of the images obtained in respective fields of view;
a storage that stores a data for recognizing a target;
a recognizing unit that recognizes the target in the area of each of the images obtained in respective fields of view;
an evaluation unit that obtains evaluation values for the respective fields of view;
a selection unit that selects one of the fields of view based on the evaluation values; and
an output unit that outputs a result of recognizing the target from the image obtained in the selected one of the fields of view.

9. The image monitoring apparatus according to claim 8, wherein the evaluation values for respective fields of view indicate degrees of ability to obtain images recognizable in the recognizing unit.
